(19) United States
(12) Patent Application Publication
(10) Pub. No.: US 2014/0094057 A1
(43) Pub. Date: Apr. 3, 2014

(54) Modular Patch Panel System

(71) Applicant: PANDUIT CORP., Tinley Park, IL (US)

(72) Inventors: Samuel C. Ramey, Naperville, IL (US); Frank J. Graczyk, New Lenox, IL (US); Samuel M. Marrs, Bradley, IL (US)

(73) Assignee: Panduit Corp., Tinley Park, IL (US)

(21) Appl. No.: 13/632,238

(22) Filed: Oct. 1, 2012

(51) Int. Cl. H01R 13/60

(52) U.S. Cl. 439/540.1

(57) ABSTRACT

A modular patch panel system is provided and includes a patch panel frame, a data module removably connected to the patch panel frame, and a power module removably connected to the patch panel frame.

### BACKGROUND OF THE INVENTION

The present invention relates to a patch panel system, and more particularly, a modular patch panel system including at least one of a data module, a power module, a pass-through module, and a blank module.

### BRIEF DESCRIPTION OF THE DRAWINGS

FIG. 1 is a front perspective view of a modular patch panel system according to an embodiment of the present invention;

FIG. 2 is a partially exploded front perspective view of the modular patch panel system of FIG. 1;

FIG. 3 is a rear perspective view of the modular patch panel system of FIG. 1;

FIG. 4 is a partially exploded rear perspective view of the modular patch panel system of FIG. 3;

FIG. 5 is a front perspective view of a data module for the modular patch panel system of FIG. 1, showing four data couplers installed in the data module;

FIG. 6 is an exploded front perspective view of the data module of FIG. 5;

FIG. 7 is a rear perspective view of the data module of FIG. 5;

FIG. 8 is an exploded rear perspective view of the date module of FIG. 7;

FIG. 9 is a front perspective view of a data module for the modular patch panel system of FIG. 1, showing two data couplers and two data blanks installed in the data module;

FIG. 10 is an exploded front perspective view of the data module of FIG. 9;

FIG. 11 is a rear perspective view of the data module of FIG. 9;

FIG. 12 is an exploded rear perspective view of the data module of FIG. 11;

FIG. 13 is a front perspective view of a power module for the modular patch panel system of FIG. 1, showing one power coupler installed in the power module;

FIG. 14 is an exploded front perspective view of the power module of FIG. 13;

FIG. 15 is a rear perspective view of the power module of FIG. 13;

FIG. 16 is an exploded rear perspective view of the power module of FIG. 15;

FIG. 17 is a front perspective view of a power module for the modular patch panel system of FIG. 1, showing two power couplers installed in the power module;

FIG. 18 is an exploded front perspective view of the power module of FIG. 17;

FIG. 19 is a rear perspective view of the power module of FIG. 17;

FIG. 20 is an exploded rear perspective view of the power module of FIG. 19;

FIG. 21 is a front perspective view of a pass-through module for the modular patch panel system of FIG. 1;

FIG. 22 is an exploded front perspective view of the pass-through module of FIG. 21;

FIG. 23 is a rear perspective view of the pass-through module of FIG. 21;

FIG. 24 is an exploded rear perspective view of the pass-through module of FIG. 23;

FIG. 25 is a front perspective view of a blank module for the modular patch panel system of FIG. 1; and

FIG. 26 is a rear perspective view of the blank module of FIG. 25.

### SUMMARY OF THE INVENTION

A modular patch panel system is provided and includes a patch panel frame, a data module removably connected to the patch panel frame, and a power module removably connected to the patch panel frame.

### DETAILED DESCRIPTION

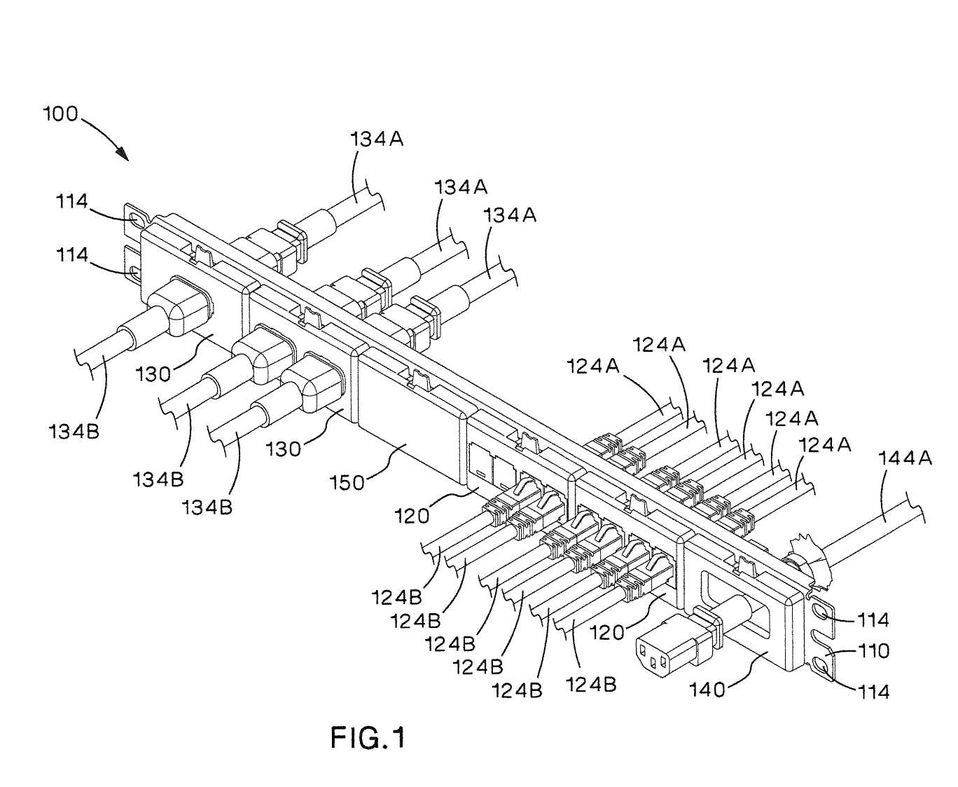

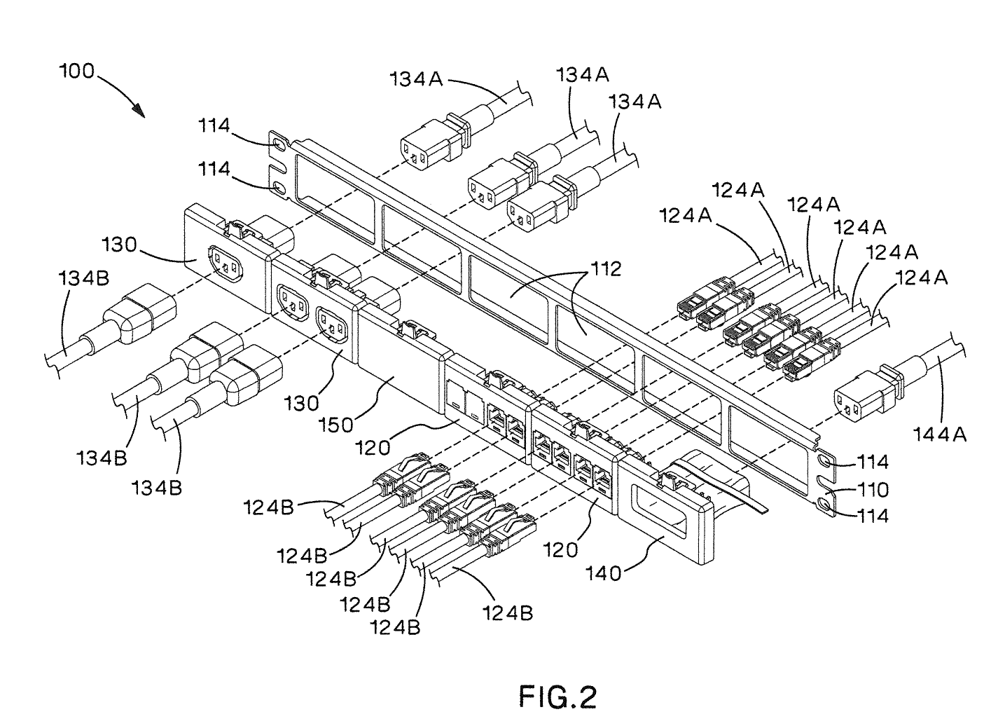

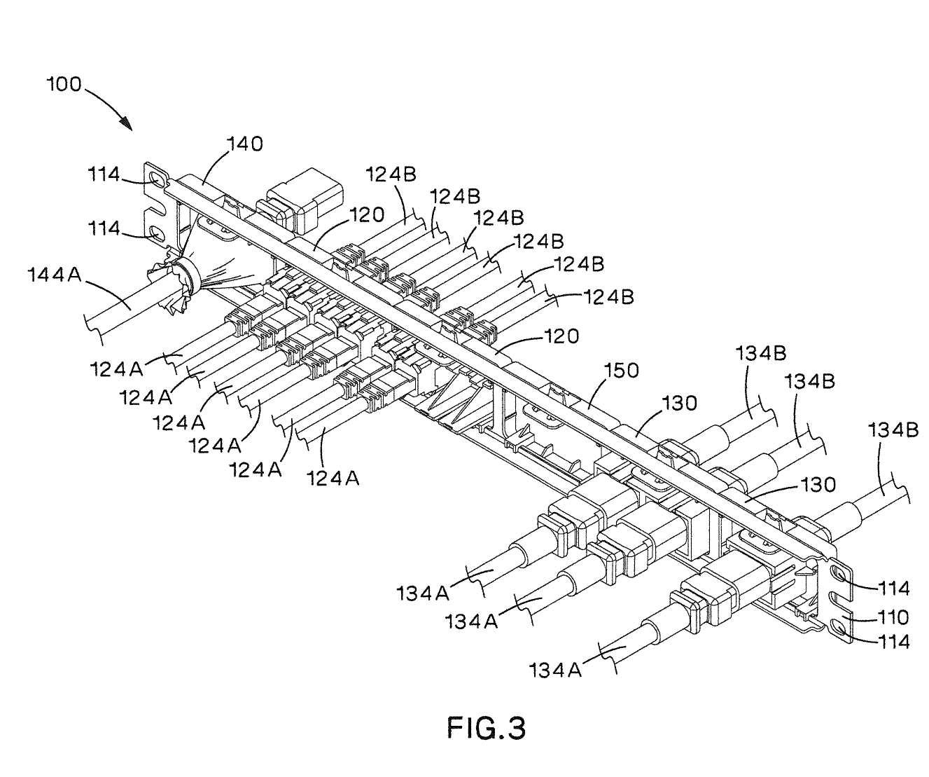

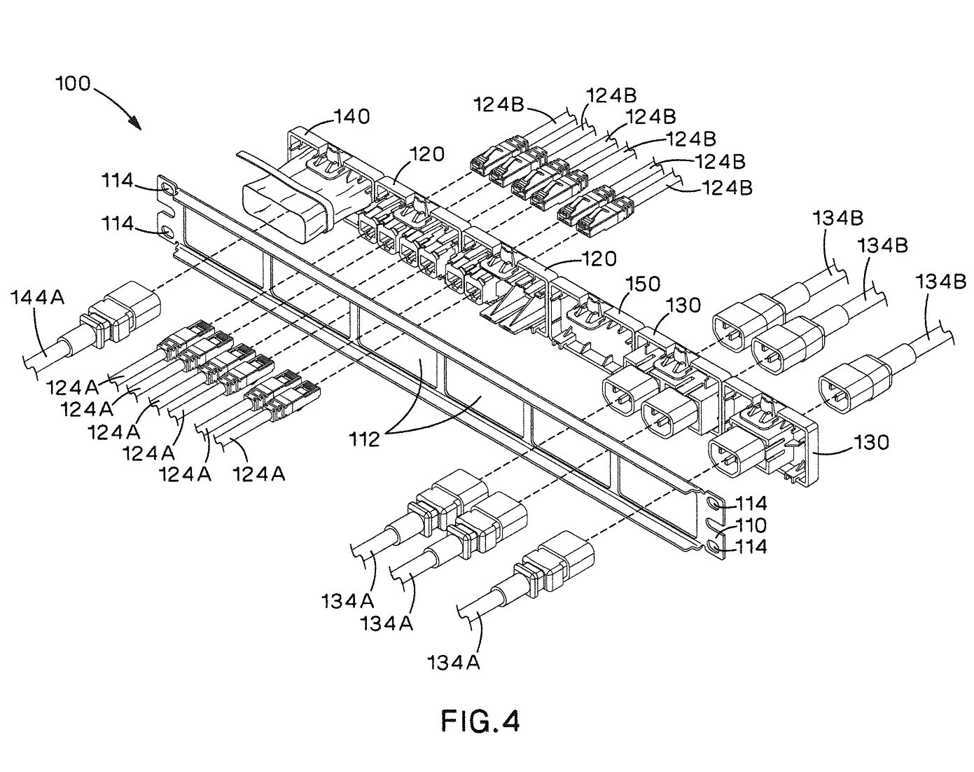

As shown in FIGS. 1-4, modular patch panel system 100 includes modular patch panel frame 110, such as Panduit's MINI-COM® Modular Patch Panel Frame. Modular patch panel frame 110 includes at least one module opening 112 for receiving a module, such as data module 120, power module 130, pass-through module 140, and blank module 150. Additionally, modular patch panel frame 110 includes at least one mounting opening 114, for example, disposed at each end of modular patch panel frame 110, for mounting modular patch panel frame 110 in an electronic equipment enclosure, such as Panduit's NET-ACCESS™ Cabinet, Panduit's NET-SERV™ Cabinet, and Panduit's 4-Post Rack. As shown in FIGS. 2 and 4, modular patch panel frame 110 includes six module openings 112 and four mounting openings 114, but it is likewise contemplated that modular patch panel frame 110 includes any number of module openings 112 and any number of mounting openings 114.

Preferably, modular patch panel system 100 includes at least one data module 120 and at least one power module 130, but it is likewise contemplated that modular patch panel frame 110 includes any combination of data modules 120, power modules 130, pass-through modules 140, and blank modules 150.

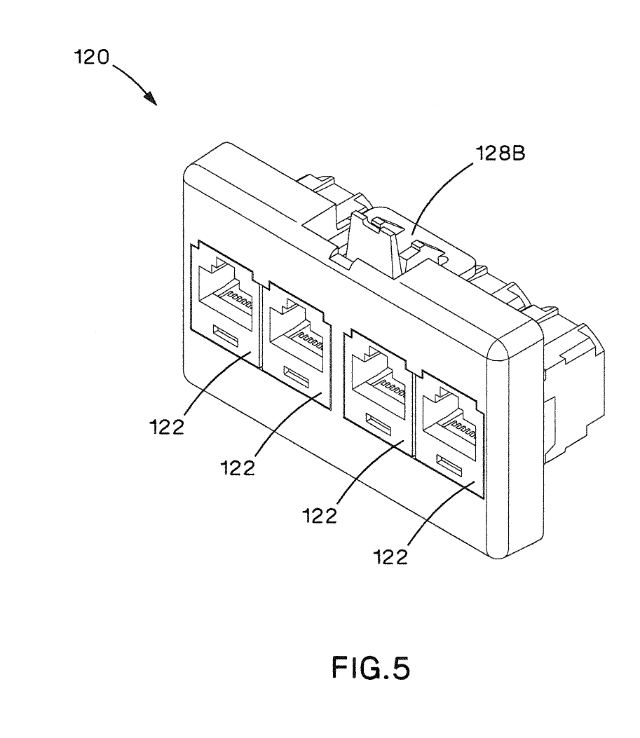

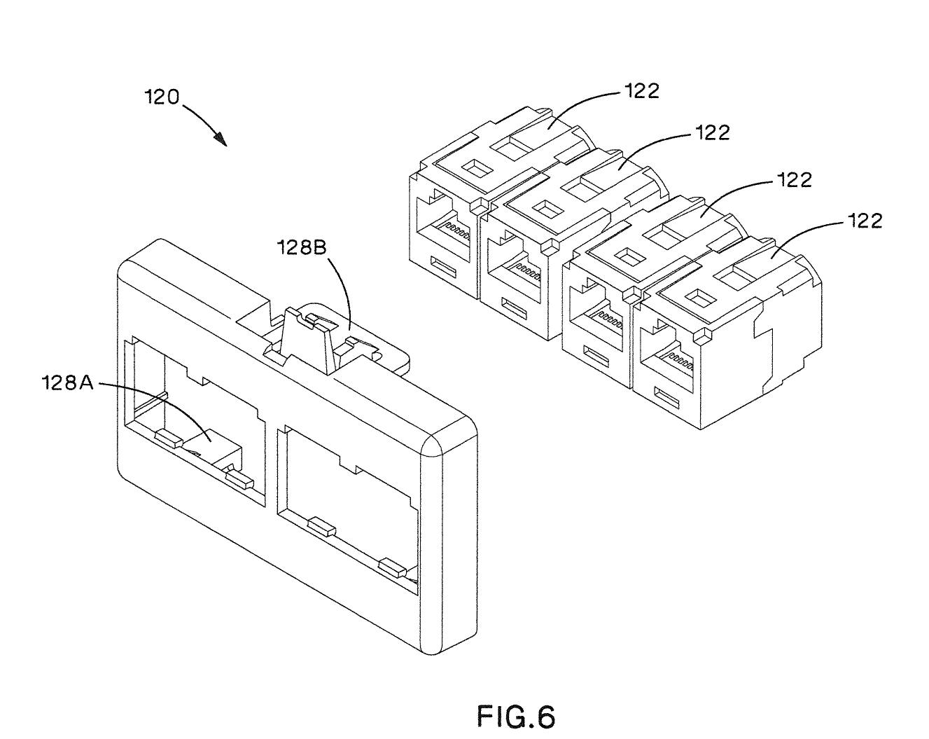

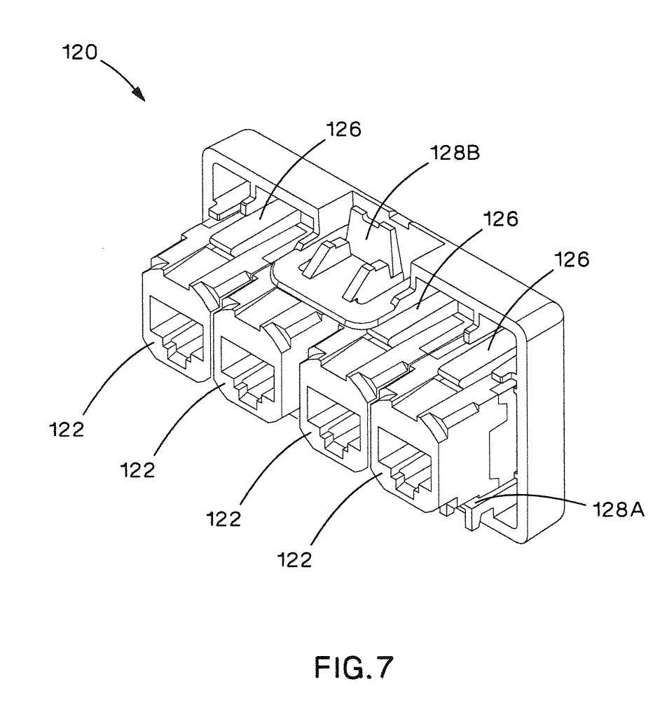

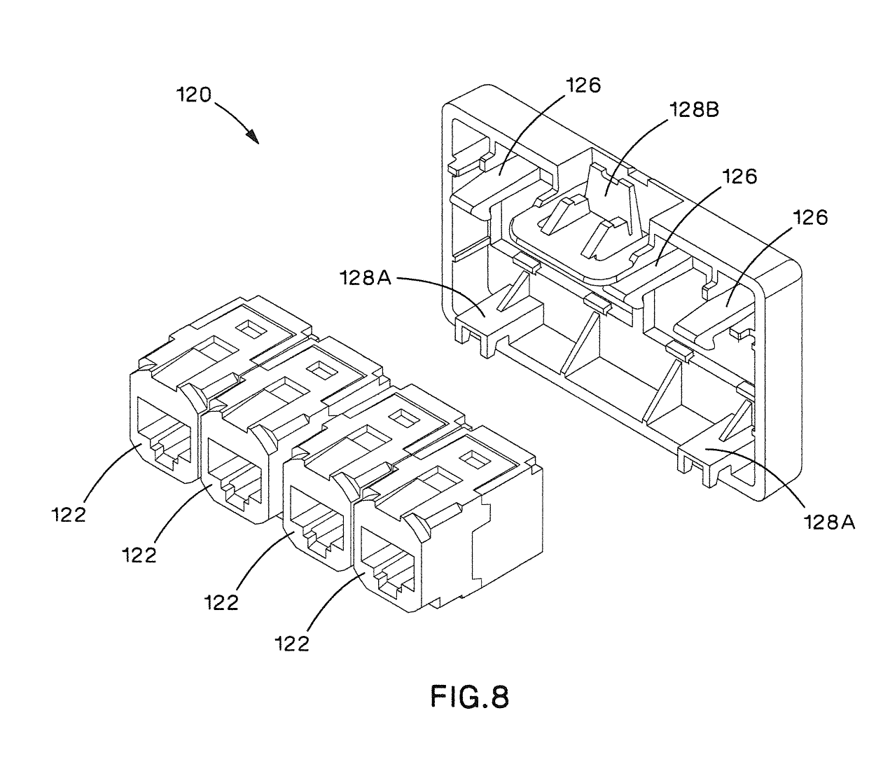

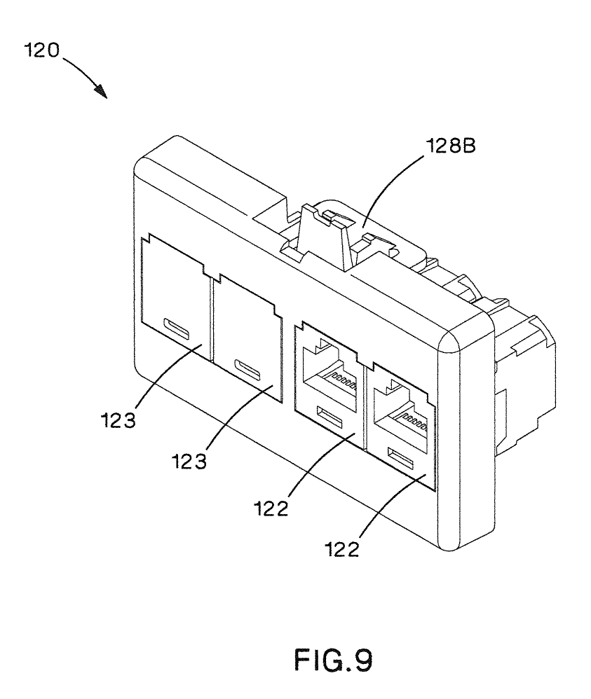

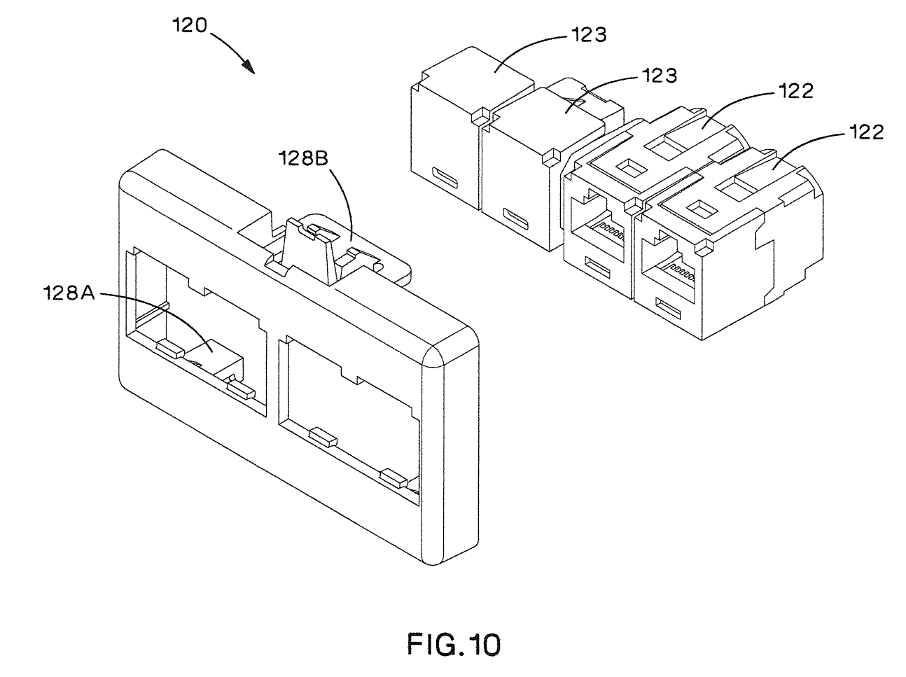

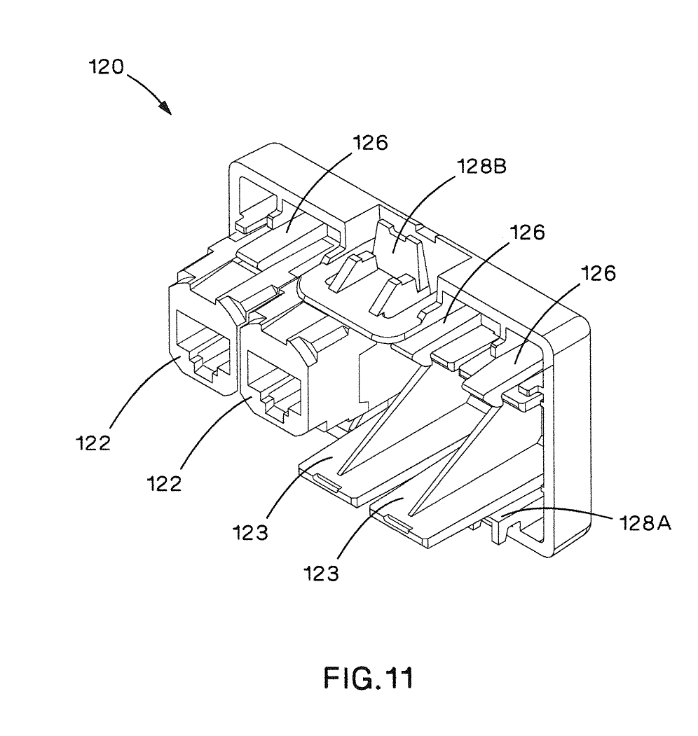

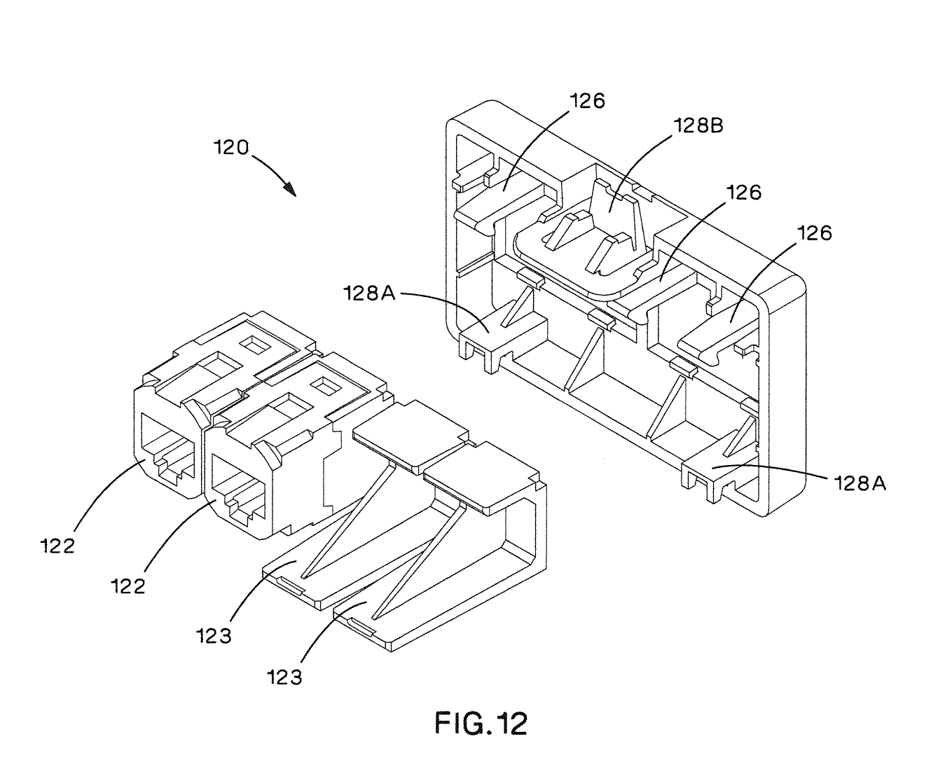

As shown in FIGS. 5-12, data module 120 includes at least one data coupler 122, such as Panduit's MINI-COM® Category 6 UTP Coupler Module, for coupling data cable 124A, such as Panduit's TX6™ Plus UTP Patch Cord, and data cable 124B, such as Panduit's TX6™ Plus UTP Patch Cord (FIGS. 1-4), which may also be referred to as data cords, patch cords, and data patch cords. Additionally, or in the alternative, data module 120 includes at least one data blank 123, such as Panduit's MINI-COM® Blank Module, for sealing any openings in data module 120 that do not include data couplers 122. Preferably, data coupler 122, as well as data blank 123, snap-fits to data module 120, for example, using latch 126, and similarly, as shown in FIGS. 1-4, data module 120 snap-fits to modular patch panel frame 110, for example, using latches 128A and latch 128B.

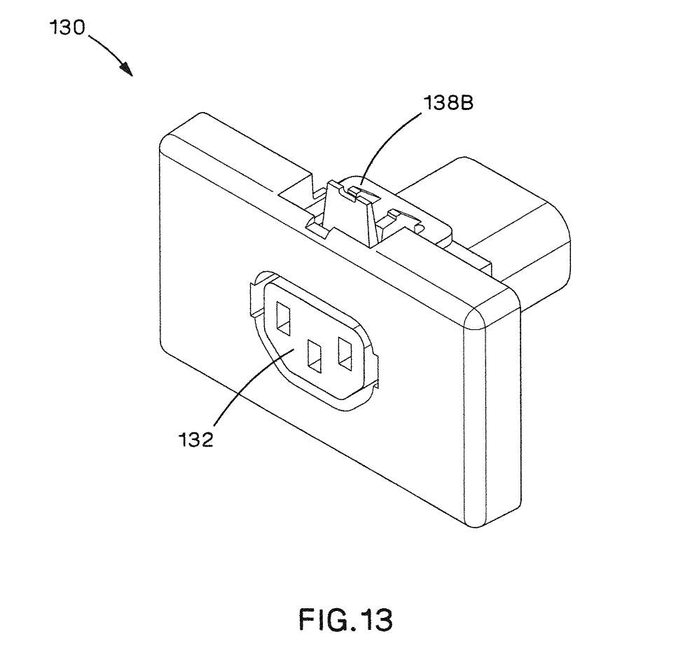

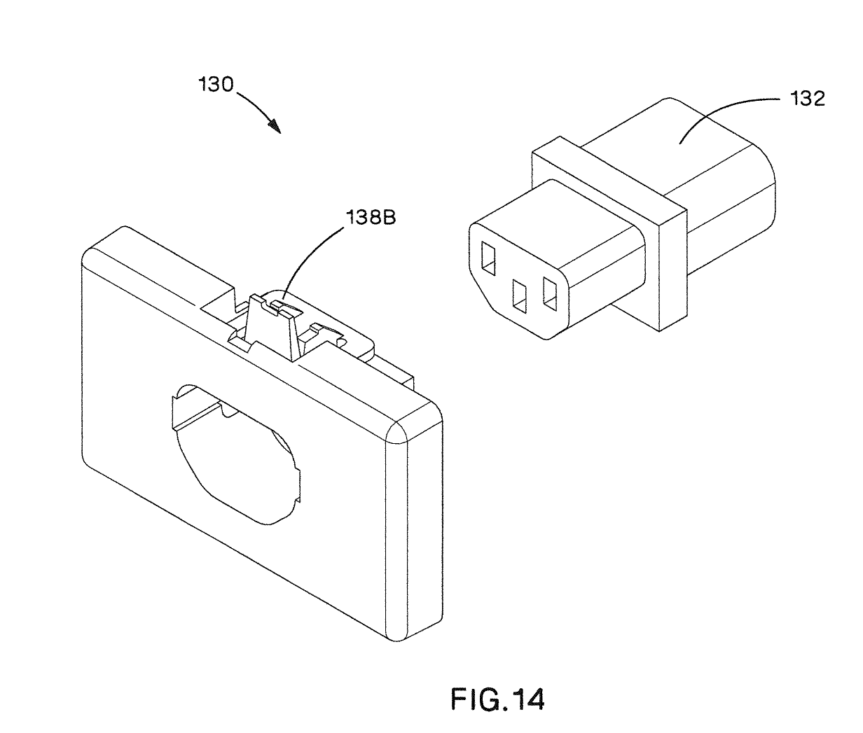

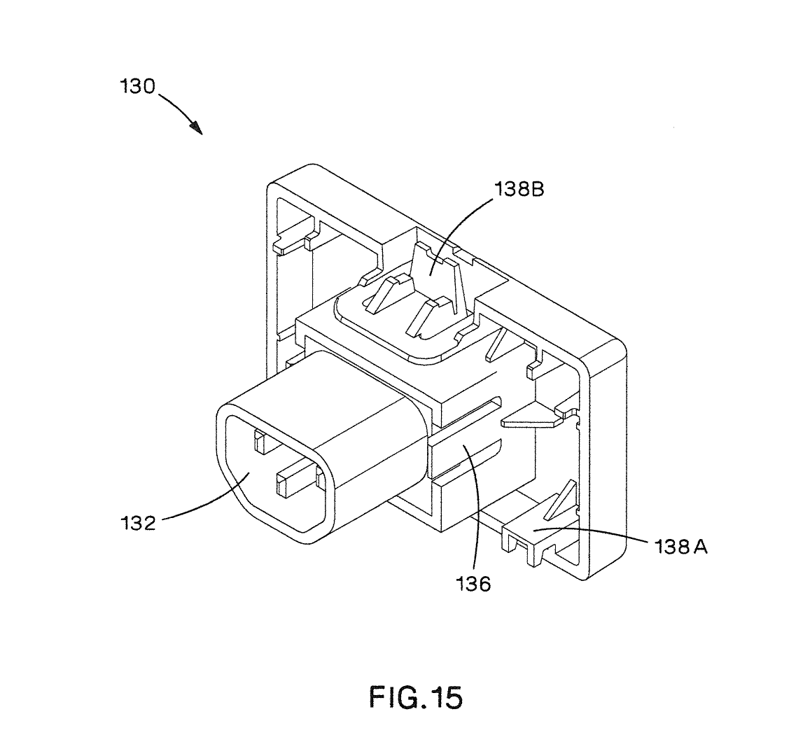

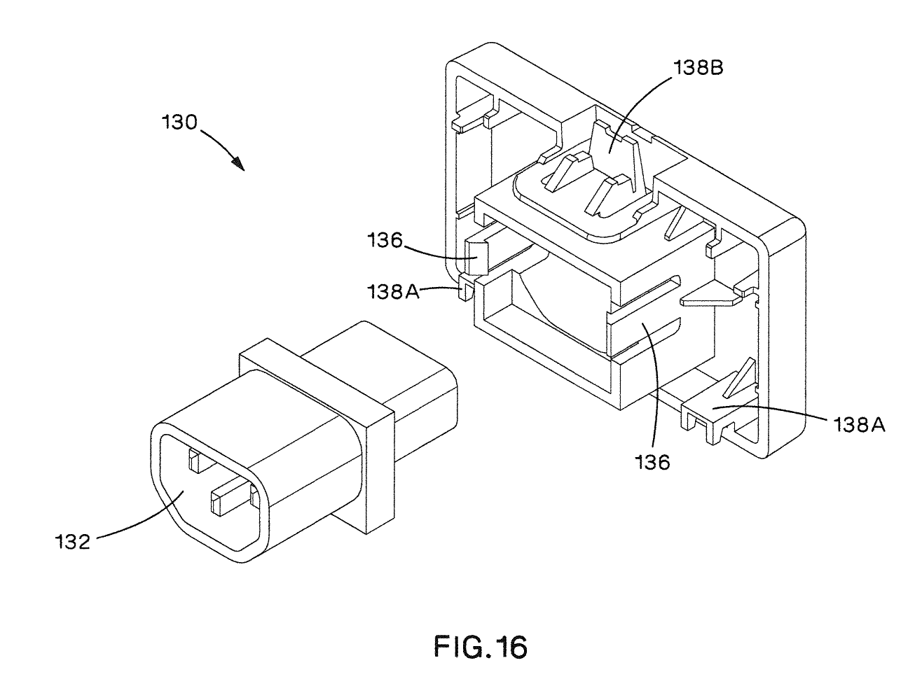

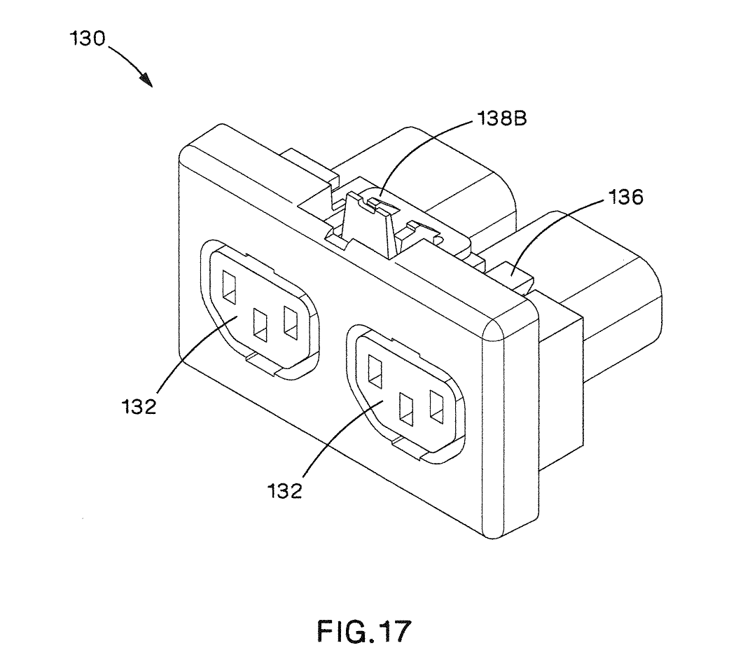

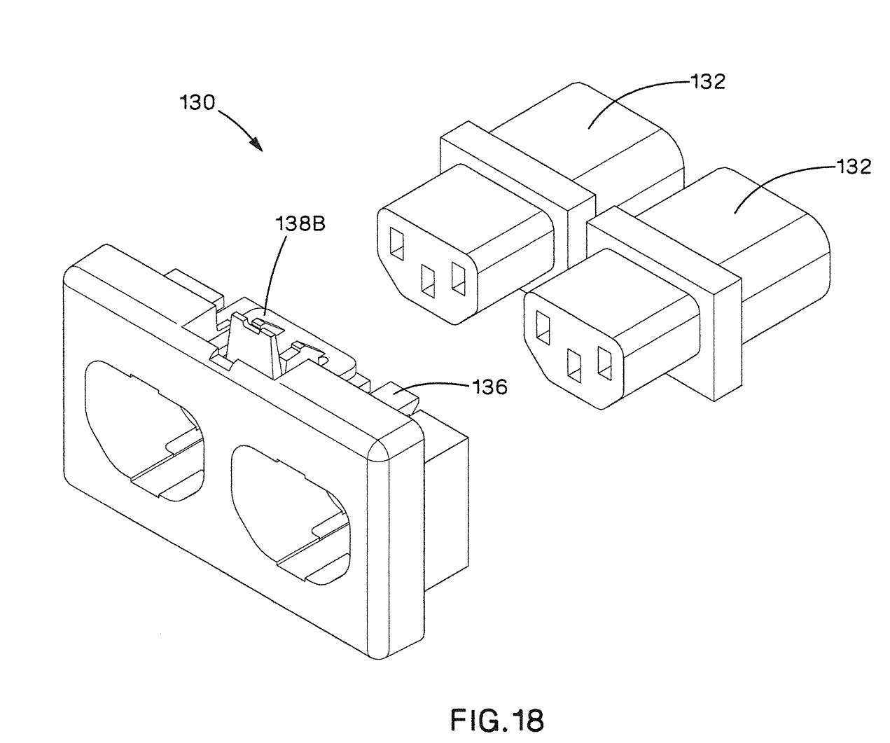

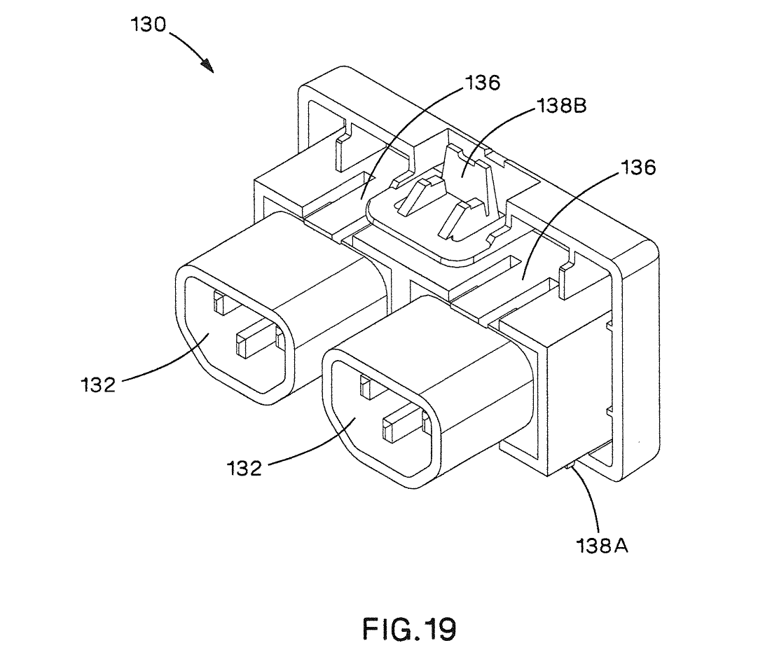

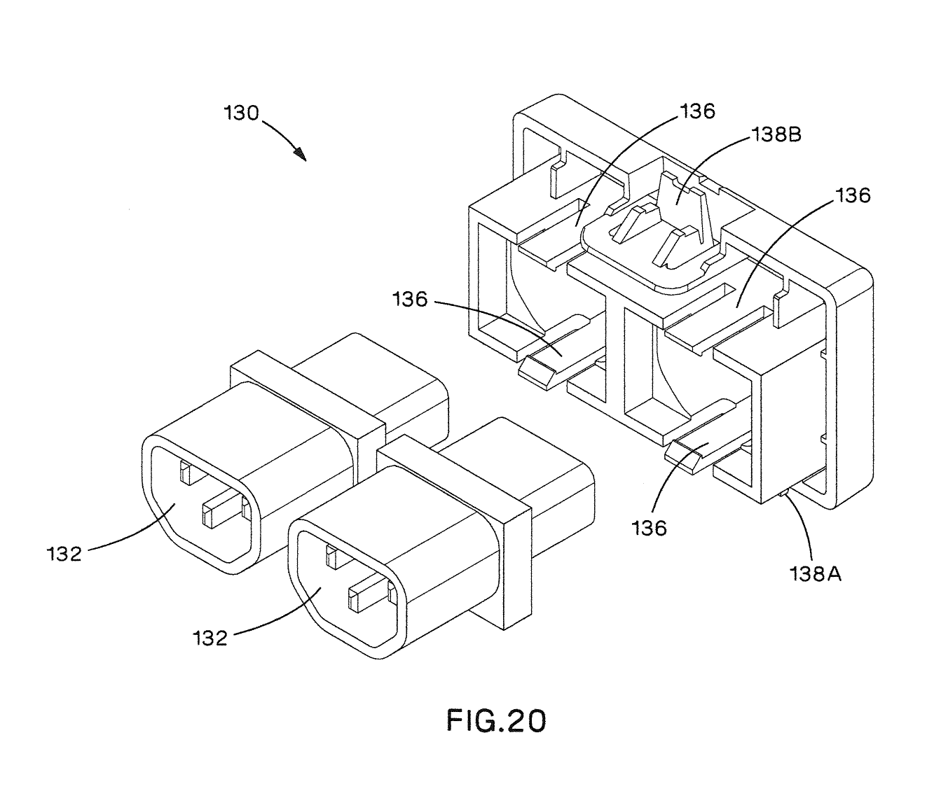

As shown in FIGS. 13-20, power module 130 includes at least one power coupler 132, such as a C13/C14 power coupler, for coupling power cable 134A, such as a C13 power cable, and power cable 134B, such as a C14 power cable (FIGS. 1-4), which may also be referred to as power cords. Preferably, power coupler 132 snap-fits to power module 130, for example, using latches 136, and similarly, as shown in FIGS. 1-4, power module 130 snap-fits to modular patch panel frame 110, for example, using latches 138A and latch 138B.

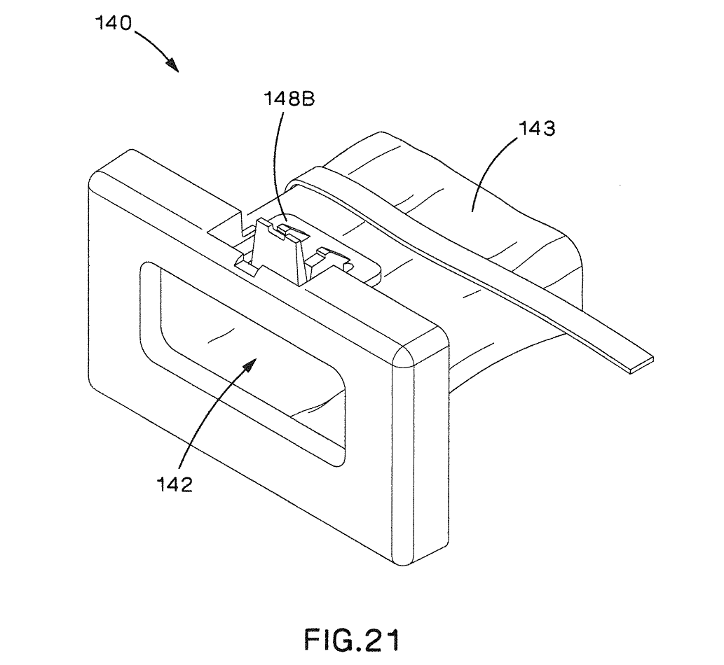

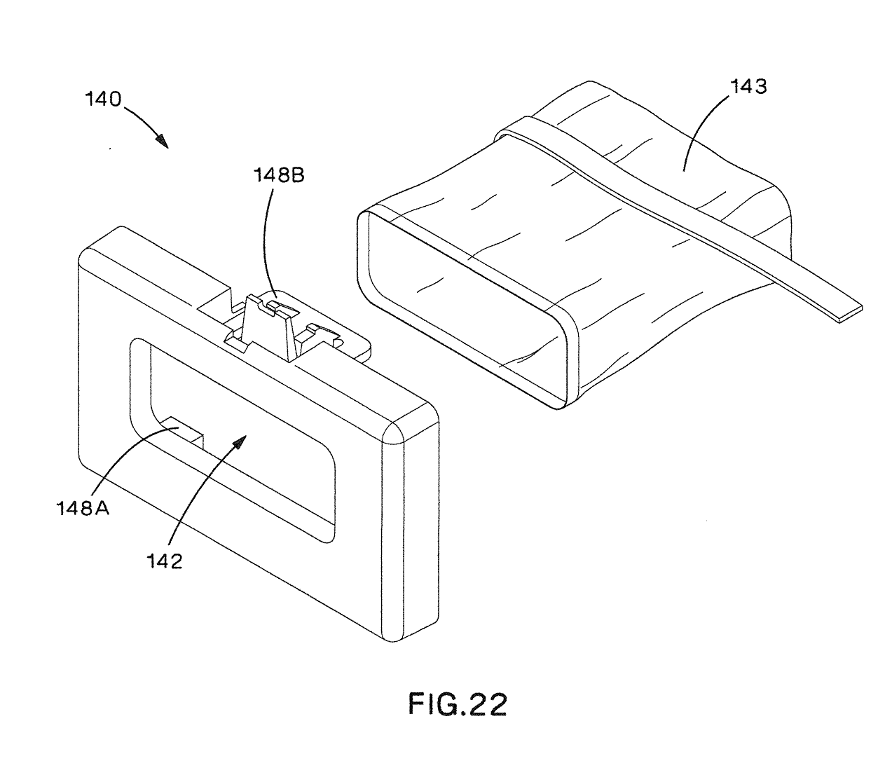

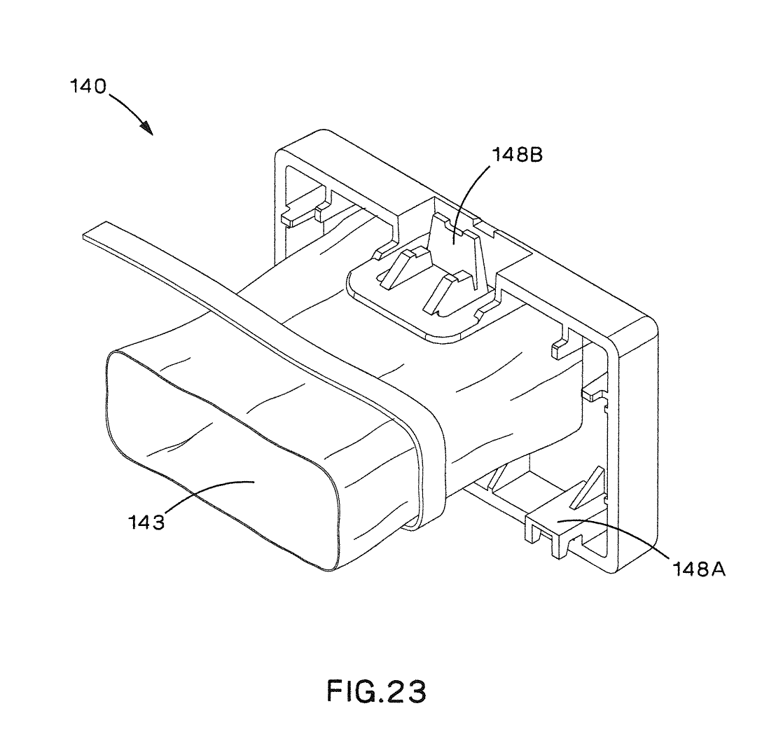

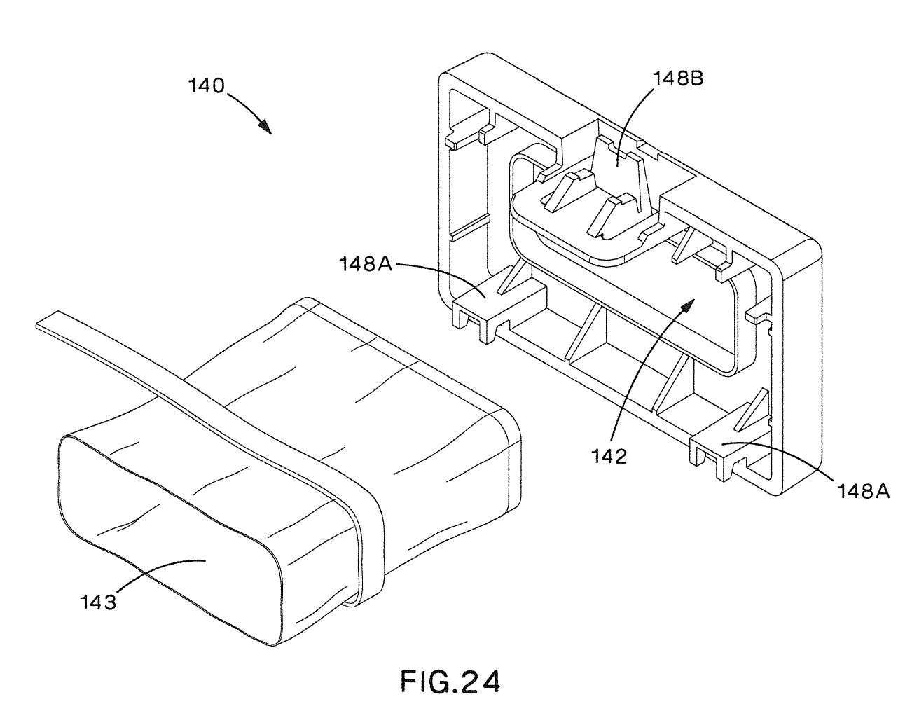

As shown in FIGS. 21-24, pass-through module 140 includes at least one pass-through opening 142 for receiving at least one cable, such as power cable 144A, which may also be referred to as a power cord. Additionally, pass-through module 140 includes air sealing grommet 143, such as Panduit's COOLBOOT® Fabric Air Sealing Grommet, CPD's AIR-BLOCK® Foam Air Sealing Grommet, and Upsite's KOLDLOK® Brush Air Sealing Grommet, for sealing pass-through opening 142 around power cable 144A. Preferably, air sealing grommet 143 snap-fits to pass-through module 140, for example, using latches (not shown), and similarly, as shown in FIGS. 1-4, pass-through module 140 snap-fits to modular patch panel frame 110, for example, using latches 148A and latch 148B.

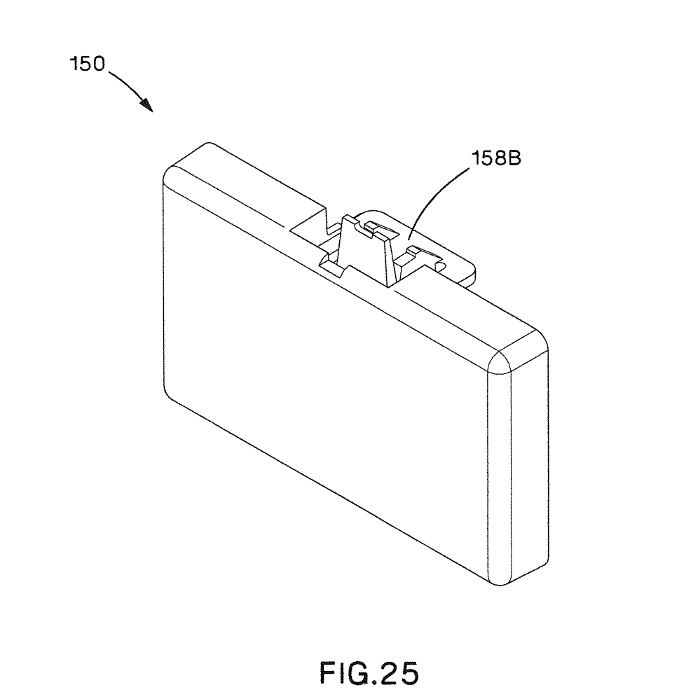

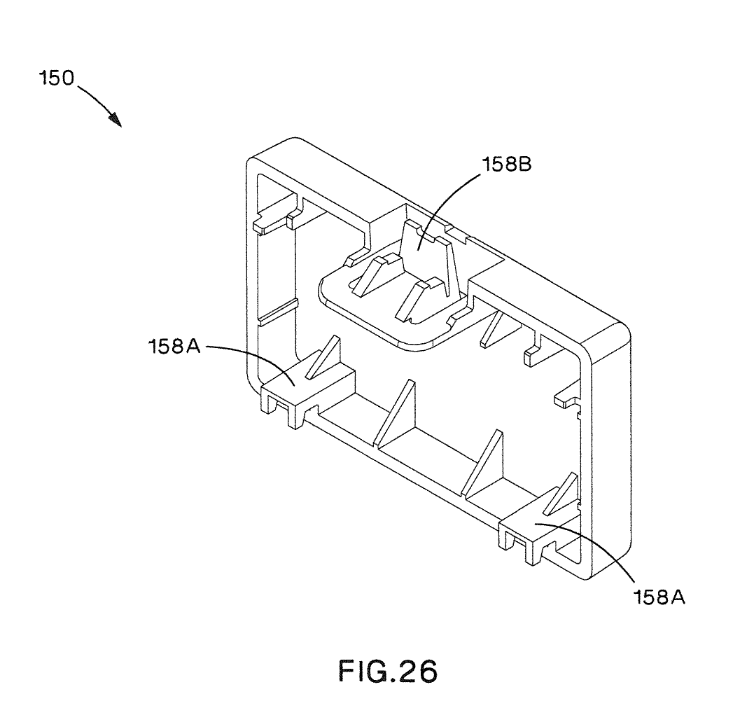

As shown in FIGS. 25 and 26, blank module 150 is for sealing module openings 112 in modular patch panel frame 110 that do not include other modules, such as data modules 120, power modules 130, and pass-through modules 140. Preferably, blank module 150 snap-fits to modular patch panel frame 110, for example, using latches 158A and latch 158B.

As shown in FIGS. 1-4, data module 120, power module 130, pass-through module 140, and blank module 150 are installed in a horizontal patch panel, but it is likewise contemplated that data module 120, power module 130, pass-through module 140, and blank module 150 are may be installed in a vertical patch panel, as well as a horizontal air dam, which may also be referred to as a horizontal blanking panel and a horizontal filler panel, and a vertical air dam, which may also be referred to as a vertical blanking panel and a vertical filler panel.

1. A modular patch panel system comprising:
a patch panel frame;
a data module removably connected to the patch panel frame; and
a power module removably connected to the patch panel frame.

2. The modular patch panel system of claim 1, wherein the patch panel frame is a horizontal patch panel.

3. The modular patch panel system of claim 1, wherein the patch panel frame is a vertical patch panel.

4. The modular patch panel system of claim 1, wherein the patch panel frame is a horizontal air dam.

5. The modular patch panel system of claim 1, wherein the patch panel frame is a vertical air dam.

6. The modular patch panel system of claim 1, wherein the data module snap-fits to the patch panel frame.

7. The modular patch panel system of claim 1, wherein the data module includes a data coupler.

8. The modular patch panel system of claim 7, wherein the data coupler is removably connected to the data module.

9. The modular patch panel system of claim 8, wherein the data coupler snap-fits to the data module.

10. The modular patch panel system of claim 1, wherein the data module includes a data blank.

11. The modular patch panel system of claim 10, wherein the data blank is removably connected to the data module.

12. The modular patch panel system of claim 11, wherein the data blank snap-fits to the data module.

13. The modular patch panel system of claim 1, wherein the power module snap-fits to the patch panel frame.

14. The modular patch panel system of claim 1, wherein the power module includes a power coupler.

15. The modular patch panel system of claim 14, wherein the power coupler is removably connected to the power module.

16. The modular patch panel system of claim 15, wherein the power coupler snap-fits to the power module.

17. The modular patch panel system of claim 1, further comprising a pass-through module removably connected to the patch panel frame.

18. The modular patch panel system of claim 17, wherein the pass-through module includes an opening for passing through a cable.

19. The modular patch panel system of claim 17, wherein the pass-through module includes an air sealing grommet.

20. The modular patch panel system of claim 1, further comprising a blank module removably connected to the patch panel frame.
